(19) United States
(12) Patent Application Publication
(10) Pub. No.: US 2007/0073632 A1
(43) Pub. Date: Mar. 29, 2007

(54) Setting up a communication connection using an embedded unique communication identifier

(75) Inventor: Gerardus Carolus Van Loo, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V. GROENEWOUDSEWEG 1, 5621 BA EINDHOVEN (NL)

(21) Appl. No.: 10/529,662

(22) PCT Filed: Sep. 17, 2003
(86) PCT No.: PCT/IB03/04122

§ 371 Date: Mar. 29, 2005

(30) Foreign Application Priority Data
Oct. 2, 2002 (EP) 02079090.3

(51) Int. Cl. G06F 17/30

(52) U.S. Cl. 707/1

(57) ABSTRACT

The invention relates to a system to be used for setting up a communication connection between a number of communication devices across a communication network. The system comprises a similar number of identification means in which the same unique communication identifier is embedded; the communication identifier is unique on the communication network on which the communication connection is to be set up. The invention also relates to a method for a first communication device to set up a communication connection to a second communication device across a communication network and to a computer readable medium for performing the method.

The invention relates to a system to be used for setting up a communication connection between a number of communication devices across a communication network. The invention also relates to a method of setting up a communication connection between communication devices across a communication network. Finally, the invention relates to a computer readable medium comprising an algorithm for setting up a communication connection between communication devices across a communication network.

When devices communicate across a communication network such as the Internet or Ethernet, it is necessary that each device on a specific communication network has a unique identification. When establishing a communication connection such as e.g. a point-to-point connection between a first and a second device on a communication network, it is necessary that the first device is identified for the second device and the second device is identified for the first device. A standard method of performing this identification is typically that a user identifies e.g. the second device to the first device by entering some kind of unique identification. By using the unique ID, the first device is then capable of transmitting its own unique ID to the second device, whereby both devices know the ID of the other device resulting in a point-to-point communication connection being established.

A more general example is described in the following where a communication system is composed of a Local Area Network (LAN), to which a number of devices are connected. The devices could either be connected via wires using e.g, Ethernet or they could be connected wireless using e.g. IEEE 802.11. One of the devices could e.g. be a DVD player, which will be referred to as the source device and the second device could be a TV-set, which will be referred to as the sink device.

It could be of interest for a user to play his DVD disk, inserted in the source device, onto the sink device by communicating between the devices using the LAN network. All devices on the LAN network are equipped with a LAN interface and with suitable means in hardware and software to send information to and receive information from each other across the network.

On the LAN, a unique ID identifies the source device and another unique ID identifies the sink device. Furthermore, the source device is equipped with additional suitable means, which could be either hardware and/or software, for reading the information from the DVD disk and sending this information onto the network to a specified device and in a format defined by the source device. The sink device is equipped with suitable means, which could be either hardware and/or software to receive information addressed specifically to the sink device, and to display this received information onto its screen. This all implies that if the source device knows the unique ID of the sink device, then a play command on the source device would result in displaying the DVD content on the screen of the sink device.

In general it can be a difficult and time-consuming process setting up network communication between a first and a second device in a communication network. These difficulties relate both to the process of identifying the ID of the second device and to the process of entering the ID of the second device in the first device.

EP 0939571 describes a method for setting up secure communication between a mobile terminal and an access node in a radio communication network. Here a secret communication key is shared between the mobile terminal and the access node. This also describes a very complex method of setting up a connection between two devices, since secret keys have to be shared before the connection can established.

It is an object of the invention to obtain a solution to the problems described above.

According to the present invention this is obtained by a system to be used for setting up a communication connection between a number of communication devices across a communication network, said system comprises a similar number of identification means in which the same unique communication identifier is embedded, said communication identifier at least being unique on the communication network on which the communication connection is to be set up. Thereby, communication connections can easily be established without the user having to manually identify communication devices, being part of communication connections, for each other.

In an embodiment at least one of said number of identification means is comprised in a plug enabled to be connected to at least one of said number of communication devices and wherein at least one of said number of communication devices comprises means for reading the identifier embedded in said identification means. Thereby, a communication device could be sold together with a number of plugs and by just plugging these plugs into other communication devices network connections are easily established without involving the user in the task of manually identifying the communication devices for each other. Further, the network connections could easily be modified by moving the plugs to other communication devices, inserting more plugs having the same unique identifier or exchanging plugs with other plugs whereby the communication device could be used in other network connections.

In a specific embodiment, at least one of said number of identification means is comprised in at least one of said number of communication devices. Thereby, a communication device is specifically intended for use with specific other identification means having the same unique identifier as the identification means included in the communication device. The other identification means could be for example a number of plugs sold with the communication device.

In an embodiment, it is a system to be used for setting up a communication connection between a first and a second communication device, comprising first and second identification means in which the same unique communication identifier is embedded. This could e.g. be a pair of devices being sold together, such as a wireless telephone comprising a telephone handle and a docking station.

In another embodiment, the information to be communicated on the communication connection is information stored on a storage device, where the second communication device comprises means for reading the information from said storage device and wherein said first communication device comprises means for processing said information. Then, the second communication device could e.g. be a DVD device or a CD device communicating with devices such as a display or an amplifier.

In another embodiment, the information to be communicated on the communication connection is data that has been received by the second communication device, where the second communication device comprises means for performing a first processing of the received data and wherein said first communication device comprises means for performing a second processing of said information. Then, the second communication device could e.g. be a television receiver or a tuner communicating with devices such as a display or an amplifier.

The invention also comprises a method for setting up a communication connection between a number of communication devices across a communication network, wherein said number of communication devices each comprise identification means in which the same unique communication identifier is embedded, said identifier being unique on the communication network on which the communication connection is to be set up, said connection being set up between the communication devices comprising corresponding communication identifiers.

The connection could e.g. be set up using a registry in which the type of device is registered on the communication connection; then a communication device such as a DVD could find out which devices provide display services and ask these devices for their attributes including the unique communication identifier. In general, a communication identifier could be send to the other devices on the network and receive the acknowledgement from communication devices having corresponding communication identifiers. A communication device could also ask for the unique communication identifier of the other communication devices present on the network and then set up the connection to other communication devices having corresponding identifiers. Further, a third party, like a central controller holding the registry of devices and thereby the unique communication identifiers could also do the matching and handle the setting up of the communication connection.

A method of setting up a connection between devices could be by identifying a connection device to the other communication devices, which is to be part of the network connection identified by the unique communication identifier and thereby setting up the connection.

The method could also be used for setting up a connection on a network like e.g. IEEE 1394 having predefined channels being used for data. In this case, the information is not addressed to a destination, but send onto a broadcast channel, where all other devices may listen on. In this case, the communication devices involved should determine the channel to be used. This could be done by setting up a control connection and then finding a channel they can share or by using the plug and execute an equal algorithm at both sides that uniquely would identify the channel, without any kind of control communication. In this case, the unique ID could e.g. be the channel id.

In a specific embodiment, the invention relates to a method for a first communication device to set up a connection to a second communication device across a communication network, wherein the first and the second communication device comprise first and second identification means in which the same unique communication identifier is embedded, said identifier being unique on the communication network on which the communication connection is to be set up, said method comprises the steps of:

reading the unique communication identifier from said first identification means,

transmitting an identification signal on the communication network, said identification signal comprising the unique identifier together with a network address being unique for said first communication device,

receiving acknowledge information from said second communication device, said second communication device being adapted for receiving the identification signal, checking if the unique communication identifier comprised in the identification signal corresponds to the unique communication identifier comprised in said second identification means and transmitting said acknowledge information if the unique identifiers are corresponding.

Thereby, a connection between two devices can be easily established in a simple and fast way.

In a specific embodiment, the acknowledge information from said second communication device to said first communication device comprises information defining the type of data which will be transmitted from the second communication device after the communication connection has been set up. Thereby, it is assured that the type of data is a mutually recognized structure, such as either MPEG2 or DVCAM or both.

In another embodiment, the acknowledge information from said second communication device to said first communication device comprises a network address being unique for said second communication device. Thereby, two-way communication can be performed between the two devices.

In a specific embodiment, the identification signal further comprises information defining the type of data that can be received by the first communication device after the communication connection has been set up. Thereby, it is assured that the type of data is a mutually recognized when performing two-way communication.

In an embodiment, the communication network is a digital communication network. Here it is especially advantageous to use the present invention because the invention is easily adapted to digital networks, such as e.g. the Ethernet.

The invention also relates to a computer readable medium comprising an algorithm for performing a method according to the above.

In the following, preferred embodiments of the invention will be described referring to the figures, wherein

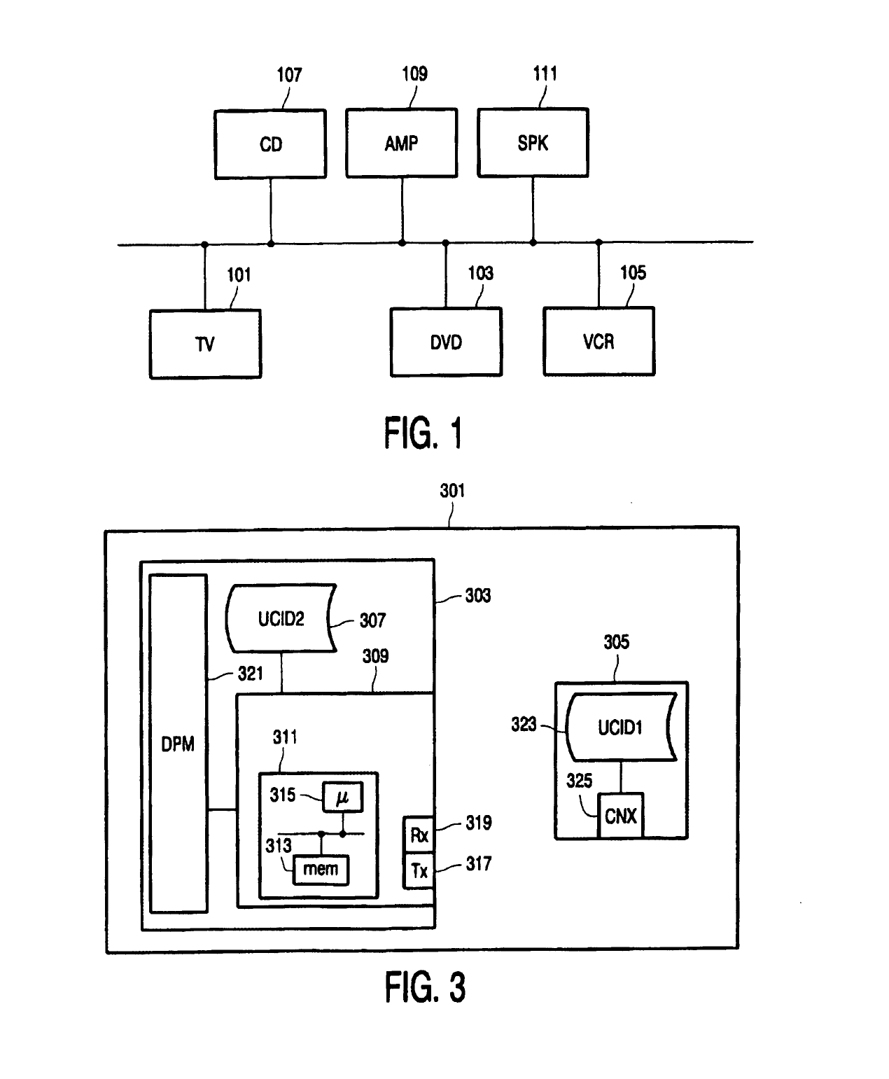

FIG. 1 illustrates a communication network where a number of devices being enabled to communicate are connected to the communication network.

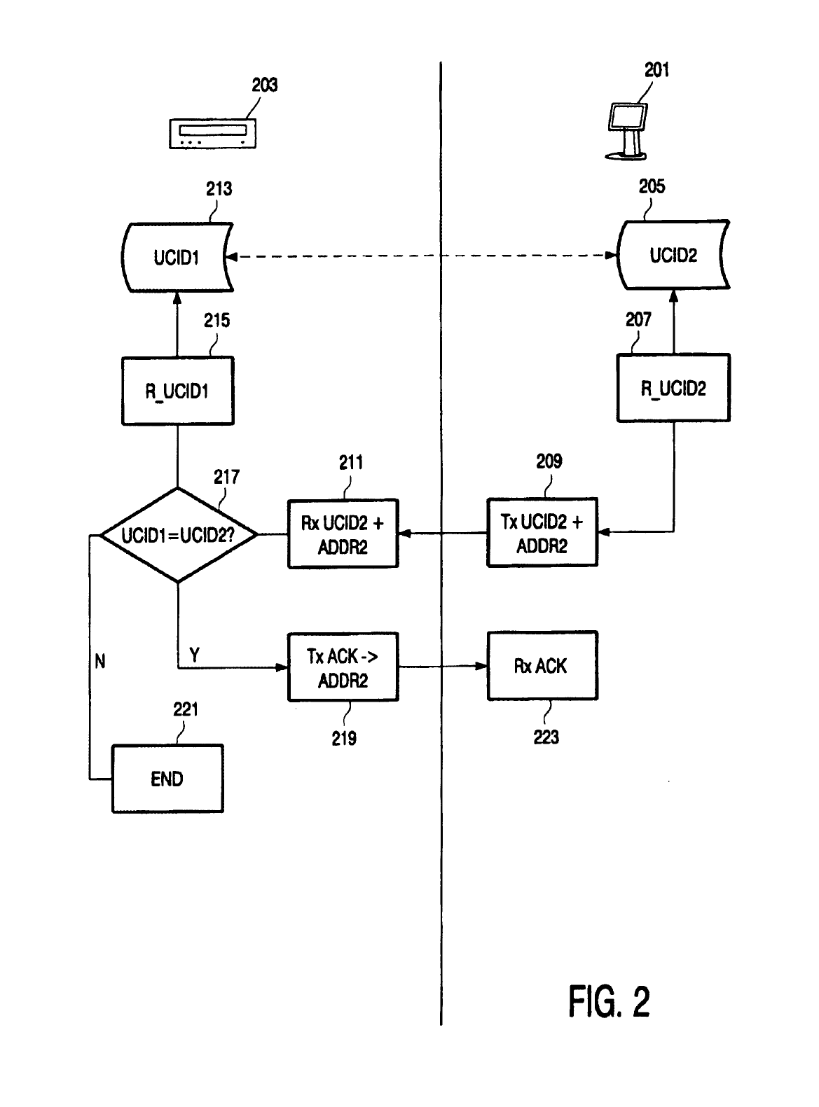

FIG. 2 is a flow diagram illustrating the process of setting up a connection according to the present invention.

FIG. 3 illustrates a system for setting up a communication connection according to the present invention.

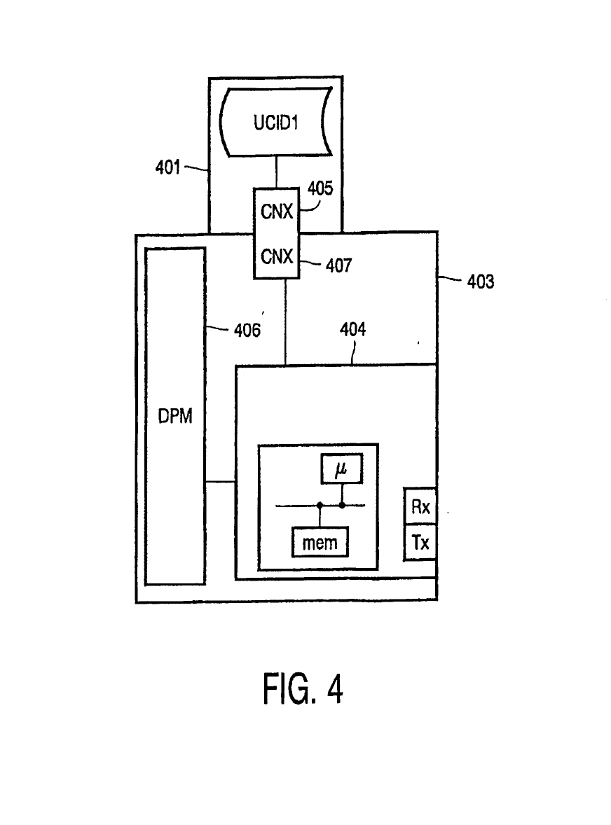

FIG. 4 illustrates a plug comprising an identifier being connected to a communication device according to the present invention.

FIG. 1 illustrates a communication network where a number of connections between devices connected to the communication network are to be set up. In the illustrated communication network, a DVD drive 103 could communicate to the TV 101 or a digital VCR 105 could communicate to the TV 101. Further, the invention could also be used for setting up a connection between a CD player 107 and an amplifier 109 and between the amplifier 109 and the speakers 111. The invention is not limited for setting up connections between audio and video devices, but can actually be used for setting up all kinds of network connections in an easy and user-friendly way.

FIG. 2 illustrates an embodiment of how a communication connection between a first communication device 201 and a second communication device 203 could be set up according to the present invention. In this example, the second communication device is illustrated as being a DVD drive and the first communication device is illustrated as being a display for displaying the content on a disc read by the DVD drive.

When a first and a second communication device are intended to communicate via a connection on a communication network, the devices will comprise corresponding unique communication identifiers. In FIG. 2, the communication identifier is illustrated as being embedded in the first identification means 205 and in the second communication device it is embedded in the second identification means 213.

When both devices 201 and 203 have been connected to the network, then in 207 the first communication device reads the unique communication identifier from the identification means 205. In 209, an identification signal is broadcasted on the communication network; the identification signal comprises the identifier having been read and a network address of the first communication device for identifying the first communication device on the communication network. Each communication device on the network then checks whether their unique communication identifier corresponds to the one having been broadcasted and a communication connection is set up between the first communication device and other communication devices on the network having a corresponding unique communication identifier. In the following, an example is described where a connection is set up between the first communication device and the second communication device.

The second communication device, which is also connected to the communication network, receives the identifier and the network address at 211. In 217, the received unique communication identifier is compared to the locally stored unique identifier, which in 215 is read from the second identification means 213. When it is established in 217 that the received and the locally stored unique communication identifier are equal, then in 219 an acknowledge is sent back to the first device 201 by using the network address received in 211. When the first device receives the acknowledge in 223, a communication connection has been set up and the connection can now be used for standard data transfer between the two devices. In another embodiment, the network address of the second communication device could be transmitted together with the acknowledge in 219, thereby a two way communication would be possible.

In the case of a DVD drive communicating with a display, the DVD drive reads content from a DVD, which is then transferred to the display across the communication network. The display processes the received data and displays the video data received from the DVD drive. In a specific embodiment, the DVD drive could also in 219 transmit information about the type of content to be transmitted, whereby the display first of all can check for compliance with the specific type of content, but also such that the display can e.g. perform a configuration according to the type of content to be received.

FIG. 3 illustrates an embodiment of a system for setting up a communication connection according to the present invention. The system 301 comprises a communication device 303 and a plug 305 both comprising the same unique communication identifier.

The communication device 303 comprises data processing means 321 enabled to process received data and a communication module 309 being connected to identification means 307 in which a unique communication identifier is embedded. The identification means 307 could e.g. comprise a ROM on which the identifier is stored. The communication module comprises a receiver 319 and a transmitter 317 connected to a computer 311, which comprises a microprocessor 315 and memory 313 interconnected via a communication bus. The microcomputer could then perform actions according to algorithms in a computer program stored in the memory 313 and the actions could, in an embodiment, be in accordance with the method described in connection with FIG. 2.

The data processing means 321 for processing the received data could be different types if processing means. If the communication device 303 e.g. were a display, then the data processing means would be the display functionality, where the input is MPEG2 data that is displayed on the display. The communication device could also be a DVD drive, where the data processing means is reading data from a DVD disc and possibly also converting the data, which is then communicated on the network using the communication module 309.

The system also comprises a plug 305 to be connected to a communication device. This plug 305 comprises an identification means 323 where a unique communication identifier is embedded; this identifier corresponds to the unique communication identifier embedded in the identification means 307. The plug further comprises a connector 325, which can be connected to a communication device.

FIG. 4 illustrates a plug comprising an identifier being connected to a communication device according to the present invention. The communication device 403 also comprises a connector 407 which can be connected to the connector 405 of the plug 401. Thereby, the communication device has access to the identifier embedded in the identification means and a communication connection can be set up according to the method described using FIG. 2. The communication device 403 also comprises data processing means 406 and a communication module 404 being connected to the connector 407.

The system according to the present invention could be communication devices where the identification means is comprised in the devices. Alternatively, the system could only be plugs enabled for being connected to communication devices. Finally, the system could comprise of a mixture of plugs and communication devices.

1. A system to be used for setting up a communication connection between a number of communication devices across a communication network, said system comprises a similar number of identification means in which the same unique communication identifier is embedded, said communication identifier at least being unique on the communication network on which the communication connection is to be set up.

2. A system according to claim 1, wherein at least one of said number of identification means is comprised in a plug enabled to be connected to at least one of said number of communication devices and wherein at least one of said number of communication devices comprise means for reading the identifier embedded in said identification means.

3. A system according to claim 1, wherein at least one of said number of identification means is comprised in at least one of said number of communication devices.

4. A system according to claim 1, wherein it is a system to be used for setting up a communication connection between a first and a second communication device, comprising first and second identification means in which the same unique communication identifier is embedded.

5. A system according to claim 4, wherein the information to be communicated on the communication connection is information stored on a storage device, where the second communication device comprises means for reading the information from said storage device and wherein said first communication device comprises means for processing said information.

6. A system according to claim 4, wherein the information to be communicated on the communication connection is data that has been received by the second communication device, where the second communication device comprises means for performing a first processing of the received data and wherein said first communication device comprises means for performing a second processing of said information.

7. A method for setting up a communication connection between a number of communication devices across a communication network, wherein said number of communication devices each comprise identification means in which the same unique communication identifier is embedded, said identifier being unique on the communication network on which the communication connection is to be set up, said connection being set up between the communication devices comprising corresponding communication identifiers.

8. A method according to claim 7, for a first communication device to set up a communication connection to a second communication device across a communication network, wherein the first and second communication device comprise first and second identification means in which the same unique communication identifier is embedded, said identifier being unique on the communication network on which the communication connection is to be set up, said method comprises the steps of:
reading the unique communication identifier from said first identification means,
transmitting an identification signal on the communication network, said identification signal comprising the unique identifier together with a network address being unique for said first communication device,
receiving acknowledge information from said second communication device, said second communication device being adapted for receiving the identification signal, checking if the unique communication identifier comprised in the identification signal corresponds to the unique communication identifier comprised in said second identification means and transmitting said acknowledge information if the unique identifiers are corresponding.

9. A method according to claim 8, wherein the acknowledge information from said second communication device to said first communication device comprises information defining the type of data which will be transmitted from the second communication device after the communication connection has been set up.

10. A method according to claim 8, wherein the acknowledge information from said second communication device to said first communication device comprises a network address being unique for said second communication device.

11. A method according to claim 8, wherein the identification signal further comprises information defining the type of data that can be received by the first communication device after the communication connection has been set up.

12. A method according to claim 7, wherein the communication network is a digital communication network.

13. A computer readable medium comprising an algorithm for performing a method according to claim 7.
